(19) United States
(12) Patent Application Publication
(10) Pub. No.: US 2015/0140200 A1
(43) Pub. Date: May 21, 2015

(54) PROCESS FOR MANUFACTURING A LI-ION BATTERY COMPRISING A FLUOROPOLYMERIC SEPARATOR

(71) Applicants: Commissariat A L'Energie Atomique Et Aux Energies Alternatives, Paris (FR); Solvay SA, Bruxelles (BE)

(72) Inventors: Hélène ROUAULT, Le Versoud (FR); Julio ABUSLEME, Saronno (VA) (IT); Daniel GLOESENER, Cognelee (BE); Sabrina PAILLET, Pau (FR); Lionel PICARD, Le Sappey En Chartreuse (FR)

(21) Appl. No.: 14/573,267

(22) Filed: Dec. 17, 2014

Related U.S. Application Data
(63) Continuation of application No. PCT/EP2013/064820, filed on Jul. 12, 2013.

(30) Foreign Application Priority Data
Jul. 16, 2012 (EP) 12176537.4

(51) Int. Cl. H01M 2/16; H01M 4/04; H01M 2/14

(52) U.S. Cl. CPC H01M 2/1653; H01M 2/145; H01M 2/1673; H01M 4/0404
USPC 427/58

(57) ABSTRACT

A method for making a Li-ion battery including the preparation of a positive electrode from an ink comprising at least one active electrode material, and at least one binder; the preparation of an electrode separator from an ink comprising at least one fluorinated copolymer; the preparation of a negative electrode from an ink comprising at least one active electrode material, and at least one binder. The fluorinated copolymer comprises: from 99.99 to 90 mol % of at least one fluorinated monomer; from 0.01 to 10 mol % of at least one acrylic acid derivative of formulae CR¹R²═CR³—C(═O)—O—R⁴ wherein each of R¹, R², R³, equal or different from each other, is independently a hydrogen atom or a C1-C3 hydrocarbon group, and R⁴ is a hydrogen or a C1-C5 hydrocarbon moiety comprising at least one hydroxyl group.

### FIELD OF THE INVENTION

The invention relates to a process for preparing a Li-ion battery comprising a fluoropolymer electrode separator.

The field of the invention concerns mostly the storage and release on demand of electrical energy. This kind of batteries may be typically used in consumer electronics such as portable electronic devices.

### BACKGROUND OF THE INVENTION

Batteries comprise one or more electrochemical units, or cells, which aim at converting stored chemical energy into electrical energy.

Each electrochemical cell of a lithium ion (Li ion) battery mostly consists of a positive electrode (cathode), an electrode separator, and a negative electrode (anode). Each electrode can be supported by a current collector that electronically isolates the positive and negative electrodes from each other.

In these lithium ion batteries, the active material of the cathode comprises a lithium compound such as a lithium oxide. On the other hand, the active material of the anode may be a carbonaceous material such as graphite. These batteries differ from regular lithium batteries essentially in that the electrode material is not metallic lithium.

The active materials of the electrode allow inserting and de-inserting lithium cations. The composition of the electrodes may also include an electronic conductor that enables the electronic conduction.

In order to manufacture relatively thin batteries, the electrodes can be printed or coated onto the current collector. These techniques afford micrometric electrodes. With this respect, adding a binder to the electrode composition may improve its coating/printing abilities onto the current collector. It may improve the homogeneity of the active material as well.

As for the electrode separator, prior art batteries generally comprise a layer made of a polyolefin or a copolymer of fluorinated monomers.

While technological innovations have led to the size reduction of electronic devices, there still subsists a need to improve the energy density of lithium ion batteries. Indeed, optimizing the thickness of the electrodes, separator, and current collector while maintaining the efficiency and capacity of the Li ion batteries remains one of the main challenges this field faces.

The Applicant has now developed a process for making lithium ion batteries comprising a thin fluoropolymer film as electrode separator.

### SUMMARY OF THE INVENTION

The present invention relates to a process for making a lithium ion battery in which the electrode separator comprises a copolymer of a fluorinated and an acrylic acid derivative monomers. Said lithium ion battery is preferably a thin battery.

The Applicant has discovered that, by means of this novel process, lithium ion batteries are obtained, wherein the electrode separator comprises a copolymer containing a fluorinated monomer and a hydrophilic monomer, said lithium ion batteries exhibiting an improved energy density as compared to conventional lithium ion batteries comprising either a polyolefin separator or a polymer exclusively made of fluorinated monomers. Their behavior during charge/discharge cycles is also improved.

More specifically, the present invention relates to a process for making a Li-ion battery comprising:
a positive electrode;
an electrode separator;
a negative electrode
   said process comprising:
the preparation of a positive electrode from an ink comprising at least one active electrode material, and at least one binder;
the preparation of an electrode separator from an ink comprising at least one fluorinated copolymer;
the preparation of a negative electrode from an ink comprising at least one active electrode material, and at least one binder,
   wherein said fluorinated copolymer comprises:
from 99.99 to 90 mol % of at least one fluorinated monomer, preferably from 99.9 to 95 mol % and even more preferably between 99.5 and 97.5 mol %; and
from 0.01 to 10 mol % of at least one acrylic acid derivative monomer of formulae CR¹R²═CR³—C(═O)—O—R⁴, preferably from 0.1 to 5 mol% and even more preferably between 0.5 and 2.5 mol%, wherein each of R¹, R², R³, equal or different from each other, is independently a hydrogen atom or a C1-C3 hydrocarbon group, and R⁴ is a hydrogen or a C 1-C5 hydrocarbon moiety comprising at least one hydroxyl group.

As opposed to the prior art membranes, the resulting electrode separator is thin and dense. Indeed, according to a preferred embodiment, it has a thickness of from 1 to 20 micrometers and a porosity of less than 30%. On the other hand, document WO2008/129041 relates to a porous membrane in which the pores have an average diameter of at least 10 micrometers. Additionally, document EP 1621573 teaches a membrane having a porosity of from 55 to 90% and a thickness that preferably ranges from 150 to 500 micrometers.

In the remaining of the description, the term “the fluorinated copolymer” refers to the fluorinated copolymer as defined above.

According to a particular embodiment, the separator is made of more than one polymeric film at least one of which being a fluorinated polymeric film obtained from the fluorinated copolymer as defined above. The electrode separator may contain more than one copolymer, it can also be a mixture of more than one fluorinated copolymer as described above.

Although, the electrode separator may comprise additional polymers; it is preferably constituted of said fluorinated copolymer or fluorinated polymeric film.

The fluorinated copolymer may be obtained by polymerizing in an aqueous medium in the presence of a radical initiator at least one fluorinated monomer and at least one acrylic acid derivative monomer. This reaction may be carried out in a reaction vessel according to the following steps:
continuously feeding an aqueous solution comprising the acrylic acid derivative monomer(s); and
maintaining in said reactor vessel an appropriate amount of fluorinated monomer(s) which may be gases at normal temperature and pressure.

As a consequence, the fluorinated copolymer may comprise randomly distributed fluorinated monomers and acrylic acid derivative monomers as described in document WO 2008/129041 for instance. Random distribution of the monomers affords blocky-type structures. The resulting uneven distribution affects the properties of the copolymer.

The fraction of randomly distributed units of acrylic acid derivatives is of preferably at least 40%, more preferably at least 50%, even more preferably of at least 60%, most preferably of at least 70%.

As described in document WO 2008/129041, said fraction corresponds to the average number of acrylic acid derivative monomer sequence per 100 identical fluorinated monomers. It can be determined by ¹⁹F NMR spectroscopy.

The fluorinated copolymer comprises preferably at least 0.01% moles, more preferably at least 0.1% moles even more preferably at most 0.5% moles of recurring units derived from said acrylic acid derivative monomers.

The fluorinated copolymer comprises preferably at most 10% moles, more preferably at most 5% moles even more preferably at most 2.5% moles of recurring units derived from said acrylic acid derivative monomers.

The acrylic acid derivative monomer of formulae CR¹R²═CR³—C(═O)—O—R⁴ is preferably hydrophilic. Non limitative examples of acrylic acid derivative monomers include the hydrophilic monomers selected from the group consisting of acrylic acid, methacrylic acid, hydroxyethyl (meth)acrylate, hydroxypropyl(meth)acrylate; hydroxyethylhexyl (meth)acrylate; and mixtures thereof.

The acrylic acid derivative monomer is more preferably selected from the group consisting of hydroxyethylacrylate (HEA); 2-hydroxypropyl acrylate (HPA); acrylic acid (AA); and mixtures thereof.

Regarding the fluorinated monomer, it is preferably selected from the group consisting of vinylidene fluoride (CF₂═CF₂); hexafluoropropylene (CF2═CF—CF₃); chlorotrifluoroethylene (CC1F═CF₂); trifluoroethylene (CF₂═CHF); the like, and mixtures thereof It is preferably vinylidene fluoride (CF₂═CF₂); hexafluoropropylene (CF₂═CF-CF₃); and mixtures thereof.

Preferably the fluorinated copolymer contains at least 70% of recurring units of vinylidene fluoride (CF₂═CF2).

The positive and negative electrodes of the lithium ion battery are preferably prepared from an electrode ink comprising:
at least one active material of electrode;
at least one binder;
optionally at least one electronic conductor.

It can be an aqueous or organic ink.

Regarding the positive electrode active material of a lithium ion battery, it may comprise a composite metal chalcogenide of formulae LiMY₂, wherein M is at least one transition metal such as Co, Ni, Fe, Mn, Cr, Al and V; and Y is a chalcogen, such as O or S.

The positive electrode material is preferably a lithium-based composite metal oxide of formulae LiMO₂, wherein M is the same as above.

Preferred examples thereof may include: LiCoO₂, LiNiO₂, LiNiₓCo₁₋ₓO₂ (0<x<1), LiNi_{0.8}Co_{0.15}Al_{0.05}O₂, and spinel-structured LiMn₂O₄. On the other hand, the negative electrode active material of a lithium battery preferably comprises a carbonaceous material, such as graphite, activated carbon or a carbonaceous material obtained by carbonization of phenolic resin, pitch.

As already said, electrode inks may comprise at least one electronic conductor. This kind of material is added in order to improve the poor electronic conductivity of active materials such as LiCoO₂ or LiFePO₄ for instance.

Said electronic conductor can be selected from the group consisting of carbonaceous materials, such as carbon black, graphite fine powder and fiber, and fine powder and fiber of metals, such as nickel and aluminum.

For both electrodes, the binder is preferably at least one fluorinated copolymer as described above.

According to a preferred embodiment, the binder(s) and the separator of the Li ion battery comprise the same fluorinated copolymer. The same fluorinated copolymer is therefore advantageously comprised in the electrode(s) and the separator.

In other words, at least one of the ink used for the preparation of the positive electrode and/or of the ink used for the preparation of the negative electrode comprises at least one binder, wherein said binder is a fluorinated copolymer comprising:
from 99.99 to 90 mol % of at least one fluorinated monomer, preferably from 99.9 to 95 mol% and even more preferably between 99.5 and 97.5 mol %;
from 0.01 to 10 mol % of acrylic acid derivatives of formulae CR¹R²═CR³—C(=O)—O—R⁴, preferably from 0.1 to 5 mol % and even more preferably between 0.5 and 2.5 mol %, wherein each of R¹, R², R³, equal or different from each other, is independently a hydrogen atom or a C1 -C3 hydrocarbon group, and R⁴ is a hydrogen or a C1-C5 hydrocarbon moiety comprising at least one hydroxyl group.

According to a particular embodiment, the binder of both the ink used for the preparation of the positive electrode and the ink used for the preparation of the negative electrode is a fluorinated copolymer as defined above.

Both electrode inks can comprise the same binder(s).

According a particular embodiment, the fluorinated copolymer of the ink for manufacturing the electrode separator is the same as the fluorinated copolymer of the binder of the ink used for the preparation of the positive electrode and/or the ink used for the preparation of the negative electrode. It is preferably the same fluorinated copolymer for both inks.

Other binders include commonly used mixtures such as carboxymethylcellulose (CMC) and a latex (SBR, styrene butadiene rubber, or NBR, Acrylonitrile Butadiene Copolymer).

The Li-ion battery preferably comprises at least one electrode comprising a binder which is the fluorinated copolymer of the electrode separator.

The electrodes can be coated of printed onto their respective current collector, according to techniques which are common general knowledge in the art.

However, according to a preferred embodiment of the invention, the electrodes are both printed onto a current collector.

The current collector can be made of a material that can be selected in the group consisting of aluminum, copper, . . .

The skilled man will be able to combine the appropriate current collector and electrode materials.

The electrode separator can be printed, coated, extruded, or casted according to prior art techniques. For instance, it can be coated onto a glass substrate. The printing techniques include serigraphy printing, helio printing, flexography printing, photogravure (heliogravure), ink jet printing.

The electrode separator can be printed or coated onto either the positive or the negative electrode. It can also be coated or printed onto both electrodes. According to another particular embodiment, it can be a self-supported polymeric film that is placed in between the electrodes.

According to a preferred embodiment, the electrode separator is printed onto one electrode or onto both electrodes. It is preferably printed onto the negative electrode.

The thickness of the electrode separator preferably ranges from 1 micrometers to 20 micrometers, more preferably between 2 and 13 micrometers, even more preferably between 2 and 8 micrometers. It is advantageously measured with a micrometer according to common practice in the art.

The electrode separator has a porosity of preferably less than 30%, more preferably less than 20%, and even more preferably less than 10%. The porosity relates to the volume of pores per unit of volume of the electrode separator.

The density of electrode separator is measured according to the ASTM standard D792-00; this density measurement is usually made at 23° C. (±2° C.) and at a relative humidity of 50% (±5). The porosity is defined as: ((voids volume/total volume of the sample)*100). As it is well known in the art, the so-defined porosity ((voids volume/total volume of the sample)* 100) can be directly derived from the density using the following equation: [1−(density of the separator/density of the solid polymer)]*100, wherein one assumes that, when immersing the electrode separator in water, water does not enter into the separator and therefore in its pores, and the solid polymer is the bulk polymer (identical to that used in order to form the separator).

According to this process, the positive and/or negative electrode can be printed or coated onto a current collector.

As already said, the electrode separator can be exclusively made of a polymeric film, which can be printed or coated onto one electrode or both the positive and negative electrodes.

According to a particular embodiment of the invention, the electrode separator is a self-supported polymeric film that is first prepared by coating a composition comprising the fluorinated copolymer onto a substrate (glass substrate for instance), and drying the resulting polymeric film. Said film is then placed in between the electrodes.

The invention and its advantages will become more apparent to one skilled in the art from the following figures and examples.

### BRIEF DESCRIPTION OF THE DRAWINGS

FIG. 1 is a graph of the discharge capacity of batteries according to both the invention and the prior art and comprising printed electrodes, as a function of the number of charge/discharge cycles.

FIG. 2 is a graph of the discharge capacity of batteries according to both the invention and the prior art and comprising coated electrodes, as a function of the number of charge/discharge cycles.

FIG. 3 is a graph of the discharge capacity of batteries according to both the invention and the prior art and comprising printed electrodes, as a function of the number of charge/discharge cycles.

### DETAILED DESCRIPTION OF EMBODIMENTS OF THE INVENTION

Examples of table 1 concern batteries comprising a separator made of a fluorinated polymer (examples 1-3, 6, 7), and batteries comprising a commercial separator (counter examples 4, 5 and 8). The density of the self-supported films of the example 3 (VF2-MA) and of the example 6 of VF2-HFP-MA have been measured according to the ASTM D792-00, obtaining respectively a porosity of 3.8% and 9%, defined as (voids volume/total volume of the sample)*100.

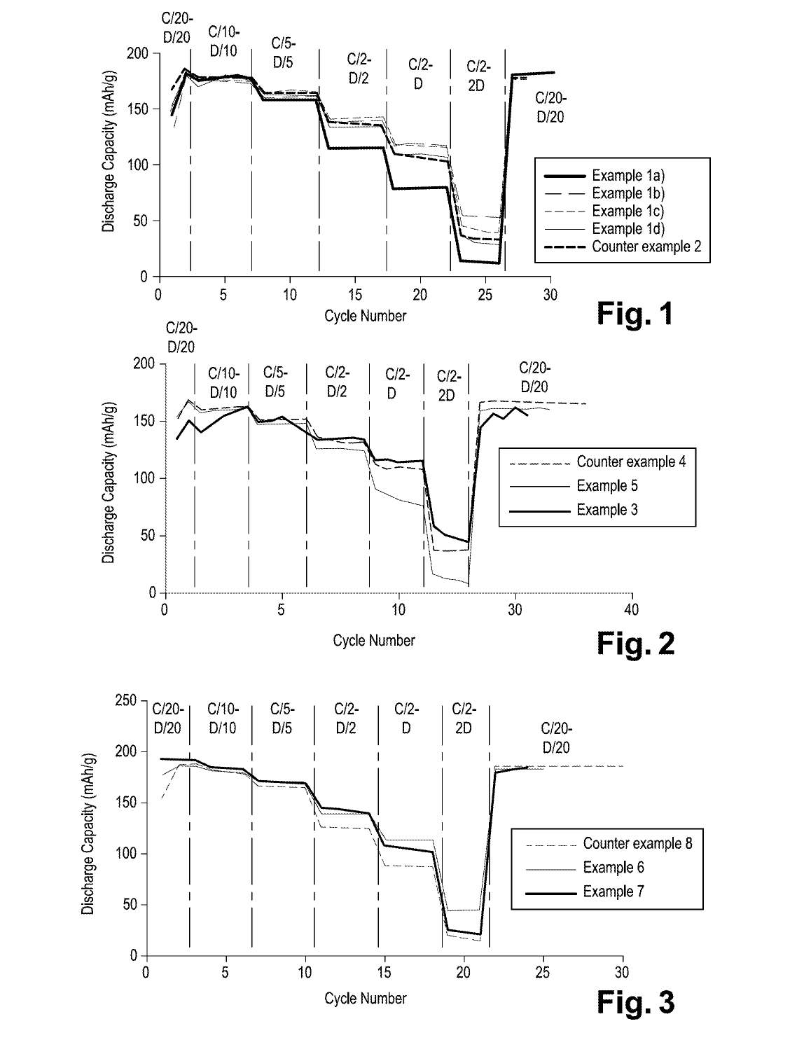

TABLE 1
BATTERIES ACCORDING TO THE INVENTION VS CONVENTIONAL BATTERIES

| EXAMPLE | CATHODE^{(a)(c)} | ANODE | ELECTRODE SEPARATOR |
|---|---|---|---|
| Examples | Ink:^{(c)} | Ink:^{(d)} | Composition: |
| 1a)-1d) | 96% NCA | 96% graphite | VF2-MA |
| (FIG. 1) | 2% VF2-MA | 2% latex | |
| | 2% EC | 2% CMC | |
| | Printed onto an aluminum | Printed onto a copper | Printed onto the anode^{(e)} |
| | current collector | current collector | Thickness^{(h)} = 3; 4; 5; 6 |
| | | | microns |
| Counter | Ink:^{(c)} | Ink:^{(d)} | Composition: |
| example 2 | 96% NCA | 96% graphite | Polyethylene^{(b)} |
| (FIG. 1) | 2% VF2-MA | 2% latex | |
| | 2% EC | 2% CMC | |
| | Printed onto an aluminum | Printed onto a copper | Self-supported |
| | current collector | current collector | Thickness = 25microns |
| Example 3 | Ink:^{(c)} | Ink:^{(d)} | Composition: |
| (FIG. 2) | 96% NCA | 96% graphite | VF2-MA |
| | 2% VF2-MA | 2% latex | |
| | 2% EC | 2% CMC | |
| | Coated onto an aluminum | Coated onto a copper | Coated onto a glass |
| | current collector | current collector | substrate^{(e)} |
| | | | Self-supported |
| | | | Thickness = 5 microns |
| Counter | Ink:^{(c)} | Ink:^{(d)} | Composition: |
| example 4 | 96% NCA | 96% graphite | VF2-HFP |
| (FIG. 2) | 2% VF2-MA | 2% latex | |
| | 2% EC | 2% CMC | |
| | Coated onto an aluminum | Coated onto a copper | Coated onto a glass |
| | current collector | current collector | substrate^{(f)} |
| | | | Self-supported |
| | | | Thickness = 5 microns |
| Counter | Ink:^{(c)} | Ink:^{(d)} | Composition: |
| example 5 | 96% NCA | 96% graphite | Polyethylene^{(b)} |
| (FIG. 2) | 2% VF2-MA | 2% latex | |
| | 2% EC | 2% CMC | |
| | Coated onto an aluminum | Coated onto a copper | Self-supported |
| | current collector | current collector | Thickness 25 microns |
| Example 6 | Ink:^{(c)} | Ink:^{(c)} | Composition: |
| (FIG. 3) | 96% NCA | 96% graphite | VF2-HFP-MA |
| | 2% VF2-MA | 4% VF2-MA | |
| | 2% EC | | |
| | Printed onto an aluminum | Printed onto a copper | Coated onto a glass |
| | current collector | current collector | substrate^{(e)} |
| | | | Self-supported |
| | | | Thickness = 6 microns |
| Example 7 | Ink:^{(c)} | Ink:^{(c)} | Composition: |
| (FIG. 3) | 96% NCA | 96% graphite | VF2-HFP-MA |
| | 2% VF2-MA | 4% VF2-MA | |
| | 2% EC | | |
| | Printed onto an aluminum | Printed onto a copper | Printed onto the anode^{(g)} |
| | current collector | current collector | Thickness = 9 microns |
| Counter | Ink:^{(c)} | Ink:^{(d)} | Composition: |
| example 8 | 96% NCA | 96% graphite | Polyethylene^{(b)} |
| (FIG. 3) | 2% VF2-MA | 2% latex | |
| | 2% EC | 2% CMC | |
| | Printed onto an aluminum | Printed onto a copper | Self-supported |
| | current collector | current collector | Thickness 25 microns |

^{(a)}weight percentages as compared to the dry weight of the ink
^{(b)}Polyethylene = Celgard ®2400 purchased from Celgard
^{(c)}ink prepared in organic solvent (NMP = N-methylpyrrolidone)
^{(d)}ink prepared in aqueous solution
^{(e)}separator obtained from a 8.7 wt % solution in THF/DMF (80/20 by weight)
^{(f)}separator obtained from a 22 wt % solution in THF/DMF (80/20 by weight)
^{(g)}separator obtained from a 5 wt % solution in MEK (butan-2-one)
^{(h)}The respective thickness of the separator according to examples 1a)-d) is 3; 4; 5; 6 microns

CMC=carboxymethylcellulose
NCA=LiNi_{0.8} Co_{0.05} Al_{0.05}O₂
VF2-MA =copolymer composition: 99 mol % vinylidene fluoride (CF₂═CF₂), and 1 mol % acrylic acid (CH₂═CH—C(═O)—OH)
VF2-HFP=copolymer composition: 97.7 mol % vinylidene fluoride (CF₂═CF₂), and 2.3 mol % hexafluoropropene (CF₂═CF—CF₃)
VF2-HFP-MA=copolymer composition: 96.7 mol % vinylidene fluoride (CF₂═CF₂), 2.3 mol % hexafluoropropene (CF₂═CF—CF₃), and 1 mol % acrylic acid (CH2═CH—C(=O)—OH)
NBR latex=Acrylonitrile Butadiene Copolymer (NBR) purchased from Polymer

Latex (solution at 41%)
EC=electronic conductor (Carbon Super P (SuperC65) from Showa Denko)

Batteries were prepared according to the compositions/inks of table 1, and tested at different charge and discharge rates, for a current load ranging from 3.0 to 4.25 volts.

In the batteries of examples 2, 5 and 8, the electrode separator is placed in between the two electrodes.

In the batteries of examples 3, 4 and 6, the electrode separator is dried and placed in between the two electrodes.

Batteries according to examples 1-2 are thin batteries packed into a soft packaging. They have been tested according to the following cycles:

C/20-D/20: 2 cycles; C/10-D/10: 5 cycles; C/5-D/5: 5 cycles; C/2-D: 4 cycles; C/2-2D; C/20-D/20 several cycles.

Batteries according to examples 3-5 are button cells. They have been tested according to the following cycles:

C/20-D/20: 2 cycles; C/10-D/10: 5 cycles; C/5-D/5: 5 cycles; C/2-D: 4 cycles; C/2-2D; C/20-D/20: several cycles.

Batteries according to examples 6-8 are flat batteries packed into a soft packaging. They have been tested according to the following cycles:

C/20-D/20: 3 cycles; C/10-D/10: 4 cycles; C/5-D/5: 4 cycles; C/2-D: 4 cycles; C/2-2D: 3 cycles; C/20-D/20 several cycles.

A C/20 charge cycle corresponds to a steady current for a 20 hour period. The amount of current is equal to the capacity C of the battery divided by 20. A discharge cycle of D/5 corresponds to a discharge lasting 5 hours.

All of these examples show that, according to the process of the invention, the lithium ion batteries so obtained exhibit improved properties as compared to conventional batteries having a polyolefin separator or a fully fluorinated separator.

It is also shown that similar properties are obtained regardless of whether the separator is self-supported or coated onto a current collector.

1. A process for making a Li-ion battery comprising:
a positive electrode;
an electrode separator;
a negative electrode
said process comprising:
the preparation of a positive electrode from an ink comprising at least one active electrode material, and at least one binder;
the preparation of an electrode separator from an ink comprising at least one fluorinated copolymer, said electrode separator having a thickness of from 1 to 20 micrometers and a porosity of less than 30%;
the preparation of a negative electrode from an ink comprising at least one active electrode material, and at least one binder;
wherein said fluorinated copolymer comprises:
from 99.99 to 90 mol % of at least one fluorinated monomer;
from 0.01 to 10 mol % of at least one acrylic acid derivative of formulae CR¹R²═CR³—C(═O)—O-R⁴ wherein each of R¹, R², R³, equal or different from each other, is independently a hydrogen atom or a C1-C3 hydrocarbon group, and R⁴ is a hydrogen or a C1-C5 hydrocarbon moiety comprising at least one hydroxyl group.

2. The process for making a Li-ion battery according to claim 1, characterized in that wherein the positive and/or negative electrode is printed or coated onto a current collector.

3. The process for making a Li-ion battery according to claim 1, wherein the electrode separator is printed onto the positive and/or negative electrode.

4. The process for making a Li-ion battery according to claim 1, wherein the electrode separator is a self-supported polymeric film that is first coated onto a substrate and then placed in between the two electrodes.

5. The process for making a Li-ion battery according to claim 1, wherein the fluorinated monomer is selected from the group consisting of vinylidene fluoride; hexafluoropropylene; chlorotrifluoroethylene; trifluoroethylene, and mixtures thereof.

6. The process for making a Li-ion battery according to claim 1, wherein the acrylic acid derivative monomer is selected from the group consisting of acrylic acid, methacrylic acid, hydroxyethyl (meth)acrylate, hydroxypropyl(meth)acrylate; hydroxyethylhexyl (meth)acrylate, and mixtures thereof

7. The process for making a Li-ion battery according to claim 1, wherein at least one of the ink used for the preparation of the positive electrode and/or of the ink used for the preparation of the negative electrode comprises at least one binder, wherein said binder is a fluorinated copolymer comprising:
from 99.99 to 90 mol % of at least one fluorinated monomer;
from 0.01 to 10 mol % of acrylic acid derivatives of formulae CR¹R²═CR³—C(═O)—O—R⁴ wherein each of R¹ R², R³, equal or different from each other, is independently a hydrogen atom or a C1-C3 hydrocarbon group, and R⁴ is a hydrogen or a C1-C5 hydrocarbon moiety comprising at least one hydroxyl group.

8. The process for making a Li-ion battery according to claim 7, wherein the binder of both the ink used for the preparation of the positive electrode and the ink used for the preparation of the negative electrode is a copolymer.

9. The process for making a Li-ion battery according to claim 8, wherein the fluorinated copolymer of the ink for manufacturing the electrode separator is the same as the fluorinated copolymer of the binder of the ink used for the preparation of the positive electrode and/or the ink used for the preparation of the negative electrode.

10. The process for making a Li-ion battery according to claim 1, wherein the fluorinated copolymer comprises from 99.9 to 95 mol % of the at least one fluorinated monomer; and from 0.1 to 5 mol % of the at least one acrylic acid derivative monomer.

11. The process for making a Li-ion battery according to claim 1, wherein the fluorinated copolymer comprises from 99.5 to 97.5 mol % of the at least one fluorinated monomer; and from 0.5 to 2.5 mol % of the at least one acrylic acid derivative monomer.

12. The process for making a Li-ion battery according to claim 1, wherein the electrode separator has a thickness of between 2 and 13 micrometers.

13. The process for making a Li-ion battery according to claim 1, wherein the electrode separator has a thickness of between 2 and 8 micrometers.

14. The process for making a Li-ion battery according to claim 1. wherein the electrode separator has a porosity of less than 20%.

15. The process for making a Li-ion battery according to claim 1. wherein the electrode separator has a porosity of less than 10%.
